(19) United States
(12) Patent Application Publication
(10) Pub. No.: US 2024/0196387 A1
(43) Pub. Date: Jun. 13, 2024

(54) CONFIGURATION OF REFERENCE BWP/CC TO COMMON TCI POOL

(71) Applicant: QUALCOMM Incorporated, San Diego, CA (US)

(72) Inventors: Fang YUAN, Beijing (CN); Tianyang BAI, Mountain View, CA (US); Yan ZHOU, San Diego, CA (US); Tao LUO, San Diego, CA (US)

(21) Appl. No.: 18/286,531

(22) PCT Filed: May 30, 2022
(86) PCT No.: PCT/CN2022/095957

§ 371 Date: Oct. 11, 2023

(30) Foreign Application Priority Data
Jun. 25, 2021 (WO) PCT/CN2021/102331

(51) Int. Cl. H04W 72/0457; H04B 7/06; H04L 5/00; H04W 72/1268; H04W 72/1273; H04W 76/20

(52) U.S. Cl. CPC H04W 72/0457; H04B 7/06968; H04L 5/001; H04W 72/1268; H04W 72/1273; H04W 76/20

(57) ABSTRACT

To facilitate TCI state update and activation to provide common QCL information, methods, apparatuses, and computer-readable storage medium are provided. An example method includes receiving, from a network entity (e.g., a base station), an indication indicating a reference bandwidth part (BWP) or component carrier (CC) for a common transmission configuration indicator (TCI) pool shared by a set of BWPs or CCs. The example method further includes communicating with the network entity (e.g., the base station) based on the reference BWP or CC.

### CROSS REFERENCE TO RELATED APPLICATIONS

This application claims the benefit of and priority to International Application No. PCT/CN2021/102331, entitled “CONFIGURATION OF REFERENCE BWP/CC TO COMMON TCI POOL” and filed on Jun. 25, 2021, and International Application No. PCT/CN2021/102321, entitled “PC PARAMETERS OF REFERENCE BWP/CC TO TCI POOL” and filed on Jun. 25, 2021, each of which is expressly incorporated by reference herein in its entirety.

### TECHNICAL FIELD

The present disclosure relates generally to communication systems, and more particularly, to wireless communication systems with wireless communication systems with reference bandwidth part (BWP) or component carrier (CC) for common transmission configuration indicator (TCI) and power control (PC) parameters of reference BWP or CC for common TCI.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a network entity (e.g., a base station), an indication indicating a reference BWP or CC for a common TCI pool shared by a set of BWPs or CCs. The memory and the at least one processor coupled to the memory may be further configured to communicate with the network entity (e.g., the base station) based on the reference BWP or CC.

In another aspect of the disclosure, a method, a computer-readable medium, and an apparatus at a network entity (e.g., a base station) are provided. The apparatus may include a memory and at least one processor coupled to the memory. The memory and the at least one processor coupled to the memory may be configured to transmit, to a UE, an indication indicating a reference BWP or CC for a common TCI pool shared by a set of BWPs or CCs. The memory and the at least one processor coupled to the memory may be further configured to communicate with the UE based on the reference BWP or CC.

In another aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a network entity (e.g., the base station), a configuration of a reference BWP or CC for a common TCI pool shared by a set of BWPs or CCs. The memory and the at least one processor coupled to the memory may be further configured to receive, from the network entity (e.g., the base station), one or more candidate sets of PC parameters associated with the set of BWPs or CCs. The memory and the at least one processor coupled to the memory may be further configured to communicate with the network entity (e.g., the base station) based on the one or more candidate sets of PCs.

In another aspect of the disclosure, a method, a computer-readable medium, and an apparatus at a network entity (e.g., the base station) are provided. The apparatus may include a memory and at least one processor coupled to the memory. The memory and the at least one processor coupled to the memory may be configured to transmit, to a UE, a configuration of a reference BWP or CC for a common TCI pool shared by a set of BWPs or CCs. The memory and the at least one processor coupled to the memory may be further configured to transmit, to the UE, one or more candidate sets of PC parameters associated with the set of BWPs or CCs. The memory and the at least one processor coupled to the memory may be further configured communicate with the UE based on the one or more candidate sets of PCs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating a network entity (e.g., a base station) in communication with a UE via a set of beams.

FIG. 5 is a diagram illustrating example communications between a UE and a network entity (e.g., a base station).

FIG. 6 is a diagram illustrating example communications between a UE and a network entity (e.g., the base station).

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

FIG. 13 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

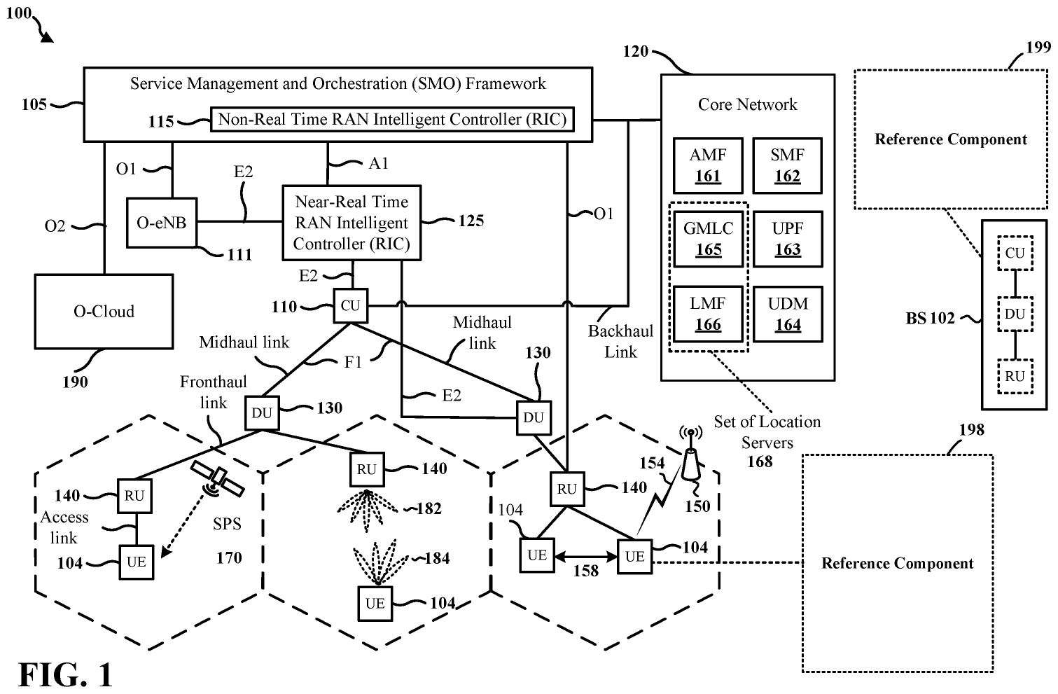

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a reference component 198. In some aspects, the reference component 198 may be configured to receive, from a network entity (e.g., a base station), an indication indicating a reference BWP or CC for a common TCI pool shared by a set of BWPs or CCs. In some aspects, the reference component 198 may be further configured to communicate with the network entity (e.g., the base station) based on the reference BWP or CC.

In some aspects, the reference component 198 may be configured to receive, from a network entity (e.g., the base station), a configuration of a reference BWP or CC for a common TCI pool shared by a set of BWPs or CCs. In some aspects, the Reference component 198 may be further configured to receive, from the network entity (e.g., the base station), one or more candidate sets of PC parameters associated with the set of BWPs or CCs. In some aspects, the reference component 198 may be further configured to communicate with the network entity (e.g., the base station) based on the one or more candidate sets of PCs.

In certain aspects, the base station 102 may include a reference component 199. In some aspects, the reference component 199 may be configured to transmit an indication indicating a reference BWP or CC for a common TCI pool shared by a set of BWPs or CCs. In some aspects, the reference component 199 may be further configured to communicate based on the reference BWP or CC.

In some aspects, the reference component 199 may be configured to transmit, to a UE, a configuration of a reference BWP or CC for a common TCI pool shared by a set of BWPs or CCs. In some aspects, the reference component 199 may be further configured to transmit, to the UE, one or more candidate sets of PC parameters associated with the set of BWPs or CCs. In some aspects, the reference component 199 may be further configured to communicate with the UE based on the one or more candidate sets of PCs.

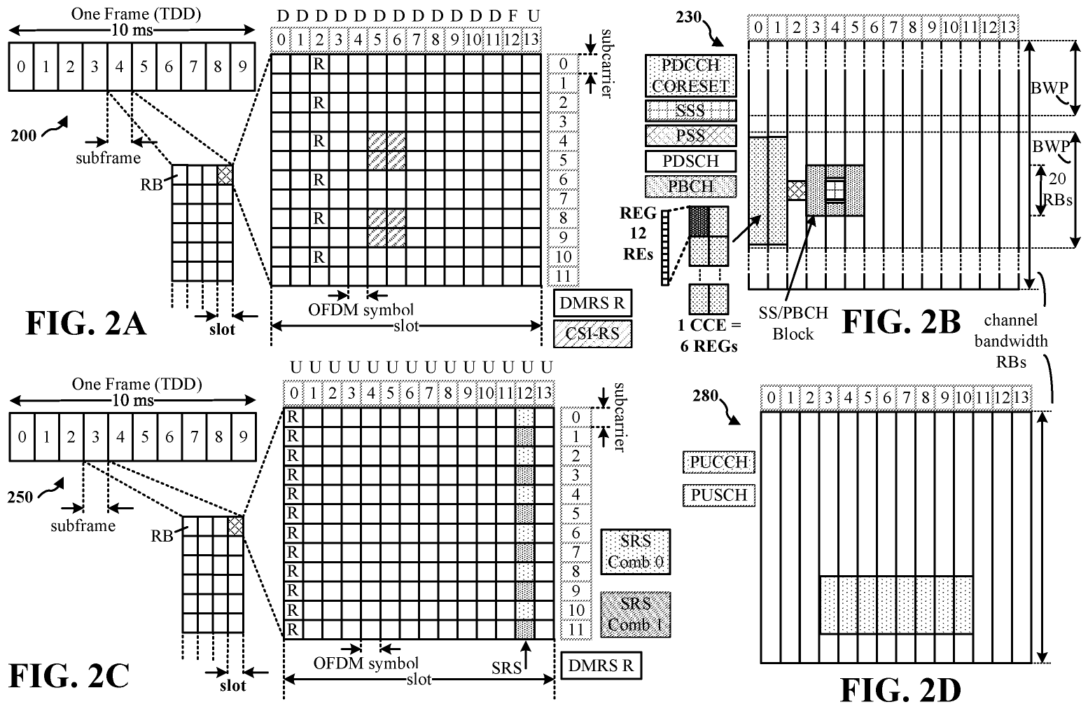

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

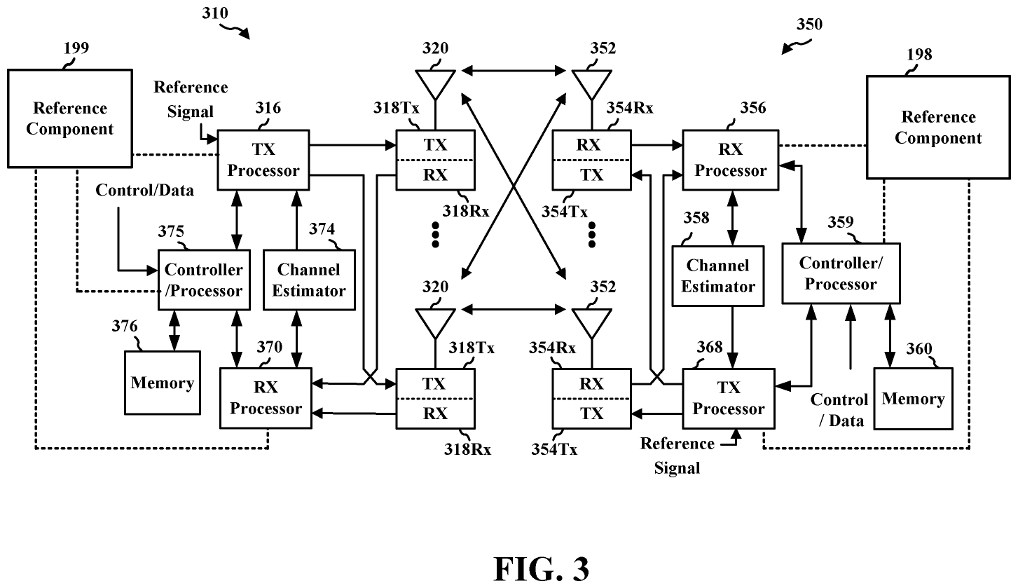

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the reference component 198 of FIG. 1.

At least one of the TX processor 316, the RX processor 370, and the controller/processor 375 may be configured to perform aspects in connection with the reference component 199 of FIG. 1.

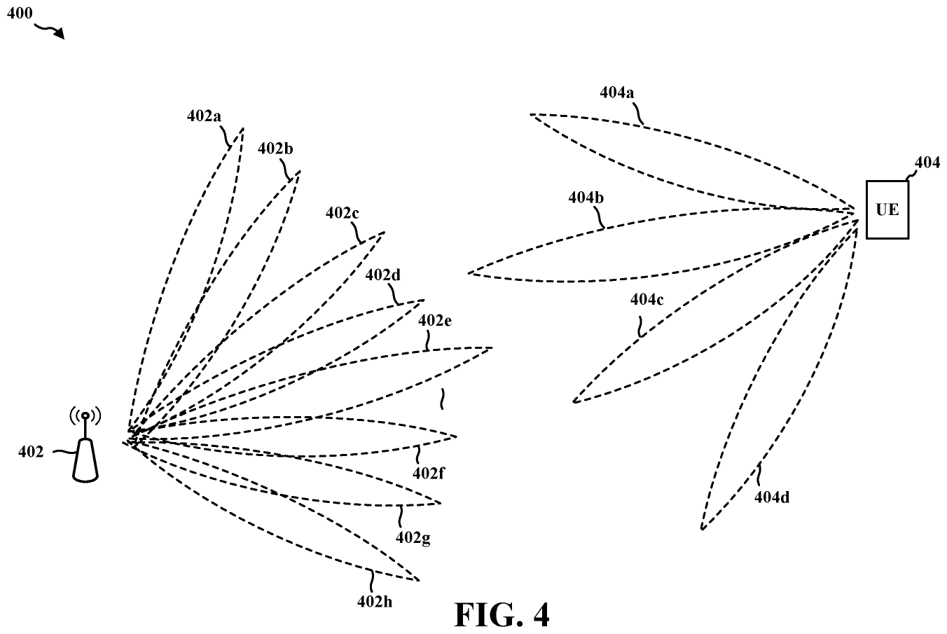

FIG. 4 is a diagram 400 illustrating a network entity 402 (e.g., a base station) in communication with a UE 404. Referring to FIG. 4, the network entity 402 may transmit a beamformed signal to the UE 404 in one or more of the directions 402a, 402b, 402c, 402d, 402e, 402f, 402g, 402h. The UE 404 may receive the beamformed signal from the network entity 402 in one or more receive directions 404a, 404b, 404c, 404d. The UE 404 may also transmit a beamformed signal to the network entity 402 in one or more of the directions 404a-404d. The network entity 402 may receive the beamformed signal from the UE 404 in one or more of the receive directions 402a-402h. The network entity 402/UE 404 may perform beam training to determine the best receive and transmit directions for each of the network entity 402/UE 404. The transmit and receive directions for the network entity 402 may or may not be the same. The transmit and receive directions for the UE 404 may or may not be the same. The term beam may be otherwise referred to as “spatial filter”. Beamforming may be otherwise referred to as “spatial filtering”.

In response to different conditions, the UE 404 may determine to switch beams, e.g., between beams 402a-402h. The beam at the UE 404 may be used for reception of downlink communication and/or transmission of uplink communication. In some examples, the network entity 402 may send a transmission that triggers a beam switch by the UE 404. A TCI state may include Quasi-colocation (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The network entity (e.g., the base station) may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the network entity 402 may indicate a TCI state change, and in response, the UE 404 may switch to a new beam according to the new TCI state indicated by the network entity 402.

In some wireless communication systems, such as a wireless communication system under a unified TCI framework, a pool of joint DL/UL TCI states may be used for joint DL/UL TCI state updates for beam indication. For example, the network entity 402 may transmit a pool of joint DL/UL TCI states to the UE 404. The UE 404 may determine to switch transmission beams and/or reception beams based on the joint DL/UL TCI states. In some aspects, the TCI state pool for separate DL and UL TCI state updates may be used. In some aspects, the network entity 402 may use RRC signaling to configure the TCI state pool. In some aspects, the joint TCI may or may not include UL specific parameter(s) such as UL PC/timing parameters, PLRS, panel-related indication, or the like. If the joint TCI includes the UL specific parameter(s), the parameters may be used for the UL transmission of the DL and UL transmissions to which the joint TCI is applied.

Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with UE-dedicated reception on PDSCH and a subset (which may be a full set) of control resource sets (CORESETs), or the like.

A TCI state may be defined to represent at least one source RS to provide a reference (e.g., UE assumption) for determining quasi-co-location (QCL) or spatial filters. For example, a TCI state may define a QCL assumption between a source RS and a target RS.

To accommodate situations where beam indication for UL and DL are separate, two separate TCI states (one for DL and another one for UL) may be utilized. For a separate DL TCI, the source reference signal(s) in M (M being an integer) TCIs may provide QCL information at least for UE-dedicated reception on PDSCH and for UE-dedicated reception on all or subset of CORESETs in a CC. For a separate UL TCI, the source reference signal(s) in N (N being an integer) TCIs provide a reference for determining common UL transmission (TX) spatial filter(s) at least for dynamic-grant or configured-grant based PUSCH and all or subset of dedicated PUCCH resources in a CC.

In some aspects, the UL TX spatial filter provided in the unified TCI state may also apply to all SRS resources in resource set(s) configured for antenna switching, codebook-based, or non-codebook-based UL transmissions.

In some aspects, each of the following DL RSs may share the same indicate TCI state as UE-dedicated reception on PDSCH and for UE-dedicated reception on all or subset of CORESETs in a CC: CSI-RS resources for CSI, some or all CSI-RS resources for beam management, CSI-RS for tracking, and DM-RS(s) associated with non-UE-dedicated reception on PDSCH and all/subset of CORESETs. Some SRS resources or resource sets for beam management may share the same indicated TCI state as dynamic-grant/configured-grant based PUSCH, all or subset of dedicated PUCCH resources in a CC.

In some wireless communication systems, to facilitate a common TCI state ID update and activation to provide common QCL information at least for UE-dedicated PDCCH/PDSCH (e.g., common to UE-dedicated PDCCH and UE-dedicated PDSCH) or common UL TX spatial filter(s) at least for UE-dedicated PUSCH/PUCCH across a set of configured CCs/BWPs (e.g., common to multiple PUSCH/PUCCH across configured CCs/BWPs), several configurations may be provided. For example, the RRC-configured TCI state pool(s) may be configured as part of the PDSCH configuration (such as in a PDSCH-Config parameter) for each BWP or CC. The RRC-configured TCI state pool(s) may be absent in the PDSCH configuration for each BWP/CC, and may be replaced with a reference to RRC-configured TCI state pool(s) in a reference BWP/CC. For a BWP/CC where the PDSCH configuration contains a reference to the RRC-configured TCI state pool(s) in a reference BWP/CC, the UE may apply the RRC-configured TCI state pool(s) in the reference BWP/CC. When the BWP/CC identifier (ID) (e.g., for a cell) for QCL-Type A or Type D source RS in a QCL information (such as in a QCL info parameter) of the TCI state is absent, the UE may assume that QCL-Type A or Type D source RS is in the BWP/CC to which the TCI state applies. In addition, a UE may report a UE capability indicating a maximum number of TCI state pools that the UE can support across BWPs and CCs in a band. Example aspects provided herein may include a reference CC or BWP and may facilitate determining the reference BWP.

Before receiving a TCI state, a UE may assume that the antenna ports of one DM-RS port group of a PDSCH are spatially QCL′d with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCL′d with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). In some aspects, a maximum number of TCI states may be 128.

In some aspects, a UE may receive a signal, from a network entity (e.g., the base station), configured to trigger a TCI state change via, for example, a medium access control (MAC) control element (CE) (MAC-CE), a downlink control information (DCI), or a radio resource control (RRC) signal. The TCI state change may cause the UE to find the best or most suitable UE receive beam corresponding to the TCI state indicated by the network entity (e.g., the base station), and switch to such beam. Switching beams may allow for an enhanced or improved connection between the UE and the network entity (e.g., the base station) by ensuring that the transmitter and receiver use the same configured set of beams for communication.

In some aspects, a spatial relation change, such as a spatial relation update, may trigger the UE to switch beams. Beamforming may be applied to uplink channels, such as a PUSCH, a PUCCH, or an SRS. Beamforming may be based on configuring one or more spatial relations between the uplink and downlink signals. Spatial relation indicates that a UE may transmit the uplink signal using the same beam used for receiving the corresponding downlink signal.

In another aspect, the network entity 402 may indicate a change in a PLRS that the UE may use to determine power control for uplink transmissions, such as a PUSCH, a PUCCH, or an SRS. In response to the change in the PLRS, the UE 404 may determine to switch to a new beam.

Some wireless communication systems may use codebook-based MIMO. MIMO systems may allow multiple independent radio terminals, each of which has one or multiple antennas that communicate with a given access point in such a way that each radio terminal can fully utilize all the spectral resources simultaneously. A MIMO system (such as the network entity 402) may employ a procedure, such as precoding, to resolve the problem of interference among the signals transmitted from an access point to the multiple terminals in the same frequency band at the same time. In a codebook-based MIMO wireless communication systems, the precoding may be selected from a standardized codebook. In a non-codebook-based MIMO, there may be no such codebook and the precoding may be dynamically determined. For some non-codebook-based MIMO in a PUSCH, an SRI field in DCI may indicate a set of precoders associated with an SRS resource set and a set of power control (PC) parameters which may include P0, alpha, closed loop index (which may be referred to as “Closedloopindex”), PLRS, or the like. P0 may represent a network entity (e.g., the base station) received power per resource block assuming a path loss of 0 decibels (dB). Alpha may represent possible values for uplink power control. Closedloopindex may be an index of the closed power control loop associated with the SRI and the associated PUSCH. A beam of the PUSCH may follow the SRS resource set. For example, all SRSs in the same SRS resource set may have a same beam and the SRI may not select a beam.

For some codebook-based MIMO in a PUSCH, an SRI field in DCI may select an SRS resource from multiple SRSs in an SRS resource set for determining a beam for PUSCH transmission. For example, different SRS selected by SRI in the SRS resource set may have different beams. A transmitted precoding matrix indicator (TPMI) in DCI may indicate precoders and the SRI field may indicate a set of power control parameters which may also include P0, alpha, Closedloopindex, PLRS, or the like. Example aspects provided herein may facilitate providing PC parameters for a reference BWP or CC, which may include P0, alpha, Closedloopindex, PLRS, or the like.

A network entity may be a network node. A network node may be implemented as an aggregated base station, as a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

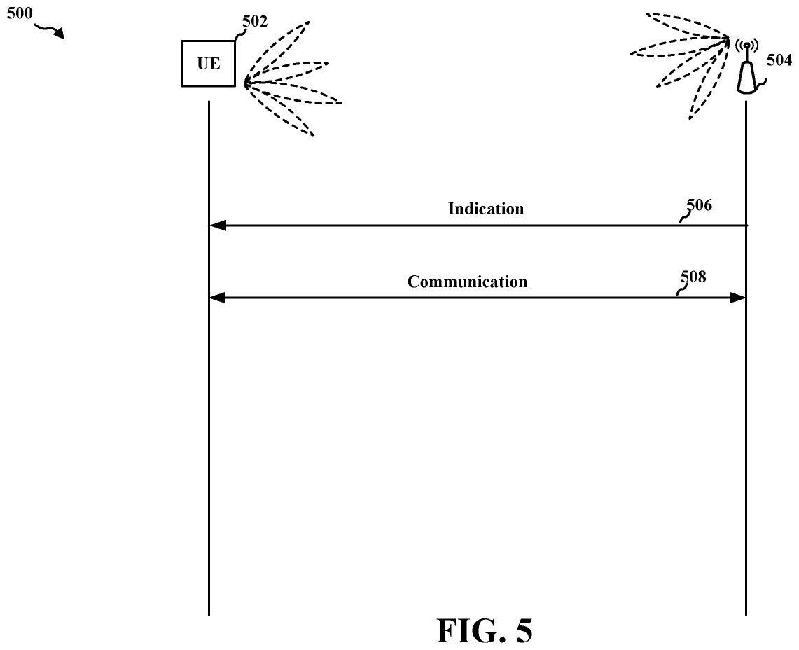

FIG. 5 is a diagram 500 illustrating example communications between a UE 502 and a network entity 504.

The network entity 504 may transmit an indication 506 to the UE 502 to indicate a reference BWP or CC for the common TCI pool shared by a set of multiple BWPs or CCs to the UE. In some aspects, the indication 506 may be an explicit indication. For example, each of BWPs or CCs associated with the reference BWP or CC may be configured with indicators to refer to the reference BWP or CC. The indicators may be included in the indication 506. In another example, a list of BWPs or CCs may be configured for indicating the BWPs or CCs associated with the reference BWP or CC. The indication 506 may include the list of BWPs or CCs. In another example, all BWPs or CCs in a CC list may be configured to have the common TCI pool indicated by the indication 506. In some aspects, the indication 506 may be an implicit indication. For example, the indication 506 may indicate that a default BWP or CC may be applied. For example, determined by a cell ID, the reference BWP or CC may be the BWP or CC with lowest BWP or cell ID among the BWPs or CCs in the same frequency band. Tables 2-5 below illustrate example configurations of the indication and associated PDSCH configurations (in a PDSCH_config parameter):

TABLE 2

| | | Indication of Reference |
|---|---|---|
| | PDSCH_config | BWP/CC |
| CC1/BWP1 | Common TCI pool | |
| CC2/BWP2 | N/A | CC1/BWP1 |
| CC3/BWP3 | N/A | CC1/BWP1 |

TABLE 3

| | | Indication of Reference |
|---|---|---|
| | PDSCH_config | BWP/CC |
| CC1/BWP1 | Common TCI pool | N/A |
| CC2/BWP2 | Common TCI pool | N/A |
| CC3/BWP3 | Common TCI pool | N/A |

TABLE 4

| | | Indication of Reference |
|---|---|---|
| | PDSCH_config | BWP/CC |
| CC1/BWP1 | Common TCI pool | List = {CC2/BWP2, |
| | | CC3/BWP3} |
| CC2/BWP2 | N/A | N/A |
| CC3/BWP3 | N/A | N/A |

TABLE 5

| | | | Indication of |
|---|---|---|---|
| | | | Reference |
| | | PDSCH_config | BWP/CC |
| FR1 | CC1/BWP1 | TCI pool1 | N/A |
| FR2 (n258) | CC2/BWP2 | TCI pool2 (default a | N/A |
| | | common TCI pool) | |
| | CC3/BWP3 | N/A | N/A |

As illustrated in Table 2, the UE is configured with a common TCI state pool in the PDSCH configuration for a BWP in a CC (e.g., ID of BWP1/CC1), and thee UE is also configured with an indicator of a reference BWP and CC (e.g., ID of BWP1/CC1) in each of BWP2/CC2 and BWP3/CC3 which share the common TCI state pool to the reference BWP and CC. As illustrated in Table 3, all BWPs/CCs sharing the same TCI state pool including CC1/BWP1, CC2/BWP2, and CC3/BWP3 may be configured to have the identical common TCI pool. As illustrated in Table 4, a list of BWPs/CCs including BWP2/CC2 and BWP3/CC3 may be configured for a BWP in a CC (e.g., ID of BWP1/CC1) where a TCI state pool is configured in the PDSCH configuration for the BWP1 in CC1. The list of BWPs/CCs including BWP2/CC2 and BWP3/CC3 are associated with the reference BWP1/CC1 for sharing the TCI state pool. In some aspects, the reference BWP/CC may be not implicitly configured. For example, as illustrated in FIG. 4, for each frequency band, UE can be configured with multiple BWP and CCs, and the BWP/CC with the lowest or highest ID number may be default as the reference BWP and CC sharing TCI state pool to other BWP and CC in the same frequency band.

Based on the configuration and the indication 506, the UE 502 and the network entity 504 may exchange communication 508 with each other. By way of example, the communication 508 may be a PDCCH, a PDSCH, a PUSCH, or a PUCCH.

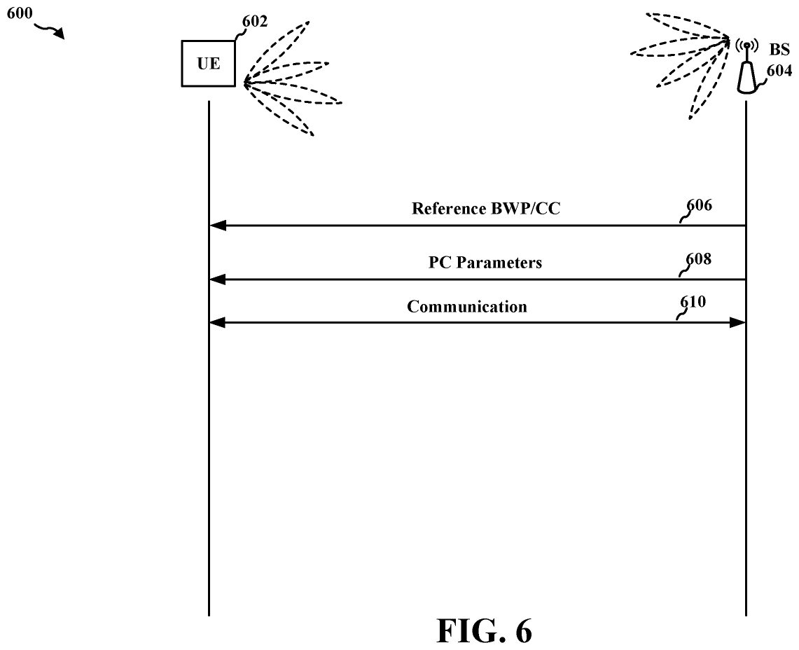

FIG. 6 is a diagram 600 illustrating example communications between a UE 602 and a network entity 604. The network entity 604 may transmit an indication to the UE 602 to indicate a reference BWP or CC 606 for the common TCI pool shared by a set of multiple BWPs or CCs to the UE. The network entity 604 may also transmit one or more sets of candidate PC parameters 608 to the UE 602 to indicate PC parameters associated with the reference BWP or CC. The PC parameters may include P0, alpha, Closedloopindex, PLRS, or the like. When UE 602 is configured with a reference RRC-configured TCI state pool(s) in a reference BWP/CC, UE may have PC parameter (any of P0, alpha, close loop index, PLRS) set configuration configured based on the one or more candidate PC parameter 608. In some aspects, multiple candidate sets of PC parameters are common and shared by multiple BWP/CCs. For example, one common set of PC parameters may be indicated per TCI. In another example, the common set of PC parameters may be independent of TCI (e.g., per an SRS source set and same to multiple SRS resources in the SRS resource set) in the common TCI pool. When the network entity (e.g., the base station) indicates the set of PC parameters per TCI, the set of PC parameters may be included in the TCI state configuration or associated by medium access control (MAC) control element (MAC-CE) signalling to a TCI state ID. In some aspects, the network entity (e.g., the base station) may configure, for the UE 602, a reference BWP/CC for the multiple set of PC parameters. The reference BWP/CC may be the same for the PC parameters and the TCI state pool. The reference BWP/CC may be different for the PC parameters and the TCI state pool. In some aspects, the multiple candidate sets of PC parameters may be configured per BWP or per CC. One individual set of PC parameters per BWP per CC may be indicated for each TCI or independent of TCI (e.g., per an SRS source set) in the common TCI pool. Tables 6-7 below illustrate example configurations of PC parameters that a network entity (e.g., the base station) may configure for a UE:

TABLE 6

| | | | PC parameter |
|---|---|---|---|
| | TCI Pool | PC parameters | per TCI |
| CC1/BWP1 | {TCI1, TCI2, | {PC parameter | {TCI1/PC parameter |
| | TCI3} | set1, PC | set1, TCI2/PC |
| CC2/BWP2 | | parameter set2} | parameter set1, |
| CC3/BWP3 | | | TCI3/parameter |
| | | | set2} |

TABLE 7

| | | | PC parameter per |
|---|---|---|---|
| | TCI Pool | PC parameters | TCI |
| CC1/BWP1 | {TCI1, TCI2, | {PC parameter | {TCI1/PC parameter |
| | TCI3} | set11, | set11, TCI2/PC |
| | | PC parameter | parameter set11, |
| | | set12} | TCI3/parameter set12} |
| CC2/BWP2 | | {PC parameter | {TCI1/PC parameter |
| | | set21, | set21, TCI2/PC |
| | | PC parameter | parameter set21, |
| | | set22} | TCI3/parameter set22} |
| CC3/BWP3 | | {PC parameter | {TCI1/PC parameter |
| | | set31, | set31, TCI2/PC |
| | | PC parameter | parameter set31, |
| | | set32} | TCI3/parameter set32} |

As illustrated in Table 6, TCI states are configured common to multiple CC/BWPs including CC1/BWP1, CC2/BWP2 and CC3/BWP3. A set of PC parameters may be configured independent of TCI and common to the multiple CC/BWPs. Another set of PC parameters may be configured dependent on TCI and common to the CC/BWPs. As illustrated in Table 7, a common TCI pool is configured to each of CC1/BWP1, CC2/BWP2 and CC3/BWP3, and each of CC1/BWP1, CC2/BWP2 and CC3/BWP3 may be configured with its own set of PC parameters. Each set of PC parameters may be configured to be dependent on TCI or independent of TCI.

Based on the reference BWP or CC 606 and the PC parameters 608, the UE 602 and the network entity 604 may exchange communication 610 with each other. By way of example, the communication 610 may be a PDCCH, a PDSCH, a PUSCH, or a PUCCH.

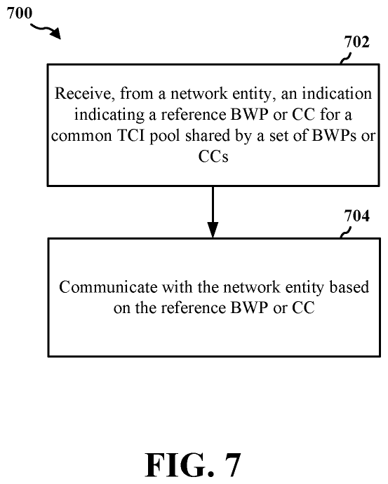

FIG. 7 is a flowchart 700 of a method of wireless communication. The method may be performed by a UE (e.g., the UE 104, the UE 404, the UE 502; the apparatus 1104). The method may be used for providing reference BWP or CC to provide common QCL information (e.g., for UE-dedicated PDCCH/PDSCH) or common UL TX spatial filter(s) (e.g., for UE-dedicated PUSCH/PUCCH across a set of configured CCs/BWPs) to improve communication quality between a UE and a network entity (e.g., a base station).

At 702, the UE may receive, from a network entity (e.g., a base station), an indication indicating a reference BWP or CC for a common TCI pool shared by a set of BWPs or CCs. For example, the UE 502 may receive, from a network entity 504, an indication indicating a reference BWP or CC for a common TCI pool shared by a set of BWPs or CCs. In some aspects, 702 may be performed by the reference component 198. In some aspects, a common TCI state ID associated with the TCI pool includes QCL information associated with a PDCCH, a PDSCH, a PUCCH, or a PUSCH. In some aspects, each BWP or each CC that is associated with the reference BWP or CC in the set of BWPs or CCs is configured with an indicator to refer to the reference BWP or CC. In some aspects, the indication includes a list of BWPs or CCs associated with the reference BWP or CC. In some aspects, each BWP or CC in the set of BWPs or CCs is associated with the reference BWP or CC. In some aspects, the indication is a BWP ID or a cell ID, and wherein the reference BWP or CC is a BWP or CC with a lowest BWP ID or a lowest cell ID in a frequency band. In some aspects, the indication is associated with a BWP. In some aspects, the indication is associated with the set of BWPs.

At 704, the UE may communicate with the network entity (e.g., the base station) based on the reference BWP or CC. For example, the UE 502 may communicate with the network entity 504 based on the reference BWP or CC. In some aspects, 704 may be performed by the reference component 198. For example, the UE may transmit one or more uplink signals/channels based on a TCI state pool associated with the reference BWP or CC. The UE may receive one or more downlink signals/channels based on the TCI state pool associated with the reference BWP or CC.

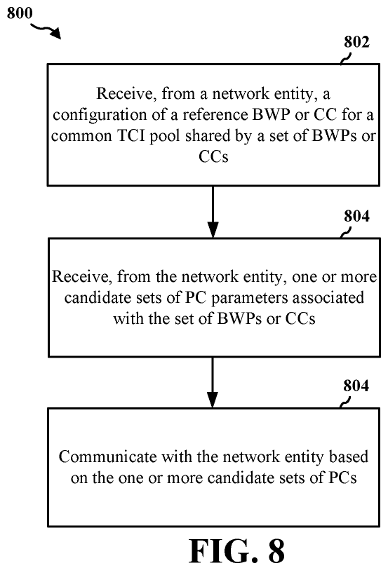

FIG. 8 is a flowchart 800 of a method of wireless communication. The method may be performed by a UE (e.g., the UE 104, the UE 404, the UE 602; the apparatus 1104). The method may be used for providing PC parameters for reference BWP or CC that may provide common QCL information (e.g., for UE-dedicated PDCCH/PDSCH) or common UL TX spatial filter(s) (e.g., for UE-dedicated PUSCH/PUCCH across a set of configured CCs/BWPs) to improve communication quality between a UE and a network entity (e.g., the base station).

At 802, the UE may receive, from a network entity (e.g., the base station), a configuration of a reference BWP or CC for a common TCI pool shared by a set of BWPs or CCs. For example, the UE 602 may receive, from a network entity 604, a configuration of a reference BWP or CC for a common TCI pool shared by a set of BWPs or CCs. In some aspects, 802 may be performed by the reference component 198. In some aspects, a common TCI state ID associated with the TCI pool includes QCL information associated with a PDCCH, a PDSCH, a PUCCH, or a PUSCH.

At 804, the UE may receive, from the network entity (e.g., the base station), one or more candidate sets of PC parameters associated with the set of BWPs or CCs. For example, the UE 602 may receive, from the network entity 604, one or more candidate sets of PC parameters associated with the set of BWPs or CCs. In some aspects, 804 may be performed by the reference component 198. In some aspects, the one or more candidate sets of PC parameters are common and shared by one or more BWPs or CCs in the set of BWPs or CCs. In some aspects, the one or more candidate sets of PC parameters includes one common set of PC parameters per each TCI in the common TCI pool. In some aspects, the one common set of PC parameters per each TCI in the common TCI pool is included in the configuration. In some aspects, the one common set of PC parameters per each TCI in the common TCI pool is associated with MAC-CE. In some aspects, the one or more candidate sets of PC parameters includes one common set of PC parameters per each SRS resource set. In some aspects, the one or more candidate sets of PC parameters are associated with the reference BWP or CC. In some aspects, the one or more candidate sets of PC parameters are configured per BWP or CC. In some aspects, each candidate set of the one or more candidate sets of PC parameters is associated with an SRS resource set. In some aspects, each candidate set of the one or more candidate sets of PC parameters is associated with a TCI in the common TCI pool.

At 806, the UE may communicate with the network entity (e.g., the base station) based on the one or more candidate sets of PCs. For example, the UE 602 may communicate with the network entity 604 based on the based on the one or more candidate sets of PCs. In some aspects, 806 may be performed by the reference component 198. For example, the UE may transmit one or more uplink signals/channels based on a TCI state pool associated with the reference BWP or CC in accordance with the PC parameters.

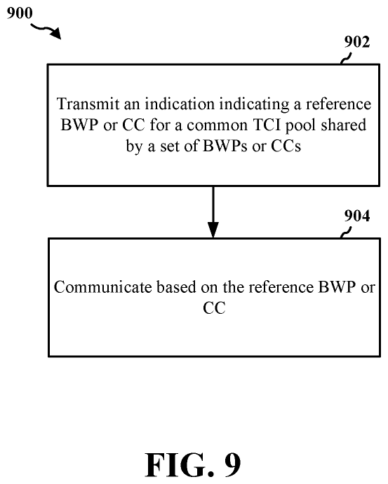

FIG. 9 is a flowchart 900 of a method of wireless communication. The method may be performed by a network entity (e.g., a base station) (e.g., the base station 102, the network entity 402, the network entity 504, the network entity 1102, the network entity 1202, the network entity 1360). The method may be used for providing reference BWP or CC to provide common QCL information (e.g., for UE-dedicated PDCCH/PDSCH) or common UL TX spatial filter(s) (e.g., for UE-dedicated PUSCH/PUCCH across a set of configured CCs/BWPs) to improve communication quality between a UE and a network entity (e.g., a base station).

At 902, the network entity (e.g., the base station) may transmit an indication indicating a reference BWP or CC for a common TCI pool shared by a set of BWPs or CCs. For example, the network entity 504 may transmit, to the UE 502, an indication indicating a reference BWP or CC for a common TCI pool shared by a set of BWPs or CCs. In some aspects, 902 may be performed by the reference component 199. In some aspects, a common TCI state ID associated with the TCI pool includes QCL information associated with a PDCCH, a PDSCH, a PUCCH, or a PUSCH. In some aspects, each BWP or each CC that is associated with the reference BWP or CC in the set of BWPs or CCs is configured with an indicator to refer to the reference BWP or CC. In some aspects, the indication includes a list of BWPs or CCs associated with the reference BWP or CC. In some aspects, each BWP or CC in the set of BWPs or CCs is associated with the reference BWP or CC. In some aspects, the indication is a BWP ID or a cell ID, and wherein the reference BWP or CC is a BWP or CC with a lowest BWP ID or a lowest cell ID in a frequency band. In some aspects, the indication is associated with a BWP. In some aspects, the indication is associated with the set of BWPs.

At 904, the network entity (e.g., the base station) may communicate based on the reference BWP or CC. For example, the network entity 504 may communicate with the UE 502 based on the reference BWP or CC. In some aspects, 904 may be performed by the reference component 199. For example, the network entity (e.g., the base station) may receive one or more uplink signals/channels based on a TCI state pool associated with the reference BWP or CC. The network entity (e.g., the base station) may transmit one or more downlink signals/channels based on the TCI state pool associated with the reference BWP or CC.

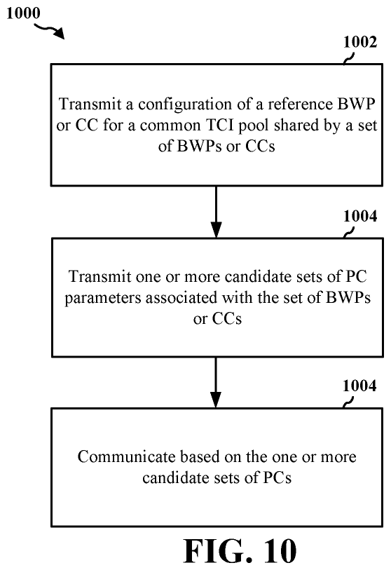

FIG. 10 is a flowchart 1000 of a method of wireless communication. The method may be performed by a network entity (e.g., the base station 102, the network entity 402, the network entity 604, the network entity 1102, the network entity 1202, the network entity 1360). The method may be used for providing PC parameters for reference BWP or CC that may provide common QCL information (e.g., for UE-dedicated PDCCH/PDSCH) or common UL TX spatial filter(s) (e.g., for UE-dedicated PUSCH/PUCCH across a set of configured CCs/BWPs) to improve communication quality between a UE and a network entity (e.g., the base station).

At 1002, the network entity (e.g., the base station) may transmit a configuration of a reference BWP or CC for a common TCI pool shared by a set of BWPs or CCs. For example, the network entity 604 may transmit, to a UE 602, a configuration of a reference BWP or CC for a common TCI pool shared by a set of BWPs or CCs. In some aspects, 1002 may be performed by the reference component 199. In some aspects, a common TCI state ID associated with the TCI pool includes QCL information associated with a PDCCH, a PDSCH, a PUCCH, or a PUSCH.

At 1004, the network entity (e.g., the base station) may transmit one or more candidate sets of PC parameters associated with the set of BWPs or CCs. For example, the network entity 604 may transmit, to the UE 602, one or more candidate sets of PC parameters associated with the set of BWPs or CCs. In some aspects, 1004 may be performed by the reference component 199. In some aspects, the one or more candidate sets of PC parameters are common and shared by one or more BWPs or CCs in the set of BWPs or CCs. In some aspects, the one or more candidate sets of PC parameters includes one common set of PC parameters per each TCI in the common TCI pool. In some aspects, the one common set of PC parameters per each TCI in the common TCI pool is included in the configuration. In some aspects, the one common set of PC parameters per each TCI in the common TCI pool is associated with MAC-CE. In some aspects, the one or more candidate sets of PC parameters includes one common set of PC parameters per each SRS resource set. In some aspects, the one or more candidate sets of PC parameters are associated with the reference BWP or CC. In some aspects, the one or more candidate sets of PC parameters are configured per BWP or CC. In some aspects, each candidate set of the one or more candidate sets of PC parameters is associated with an SRS resource set. In some aspects, each candidate set of the one or more candidate sets of PC parameters is associated with a TCI in the common TCI pool.

At 1006, the network entity (e.g., the base station) may communicate based on the one or more candidate sets of PCs. For example, the network entity 604 may communicate with the UE 602 based on the based on the one or more candidate sets of PCs. In some aspects, 1006 may be performed by the reference component 199. For example, the network entity (e.g., the base station) may receive one or more uplink signals/channels based on a TCI state pool associated with the reference BWP or CC in accordance with the PC parameters.

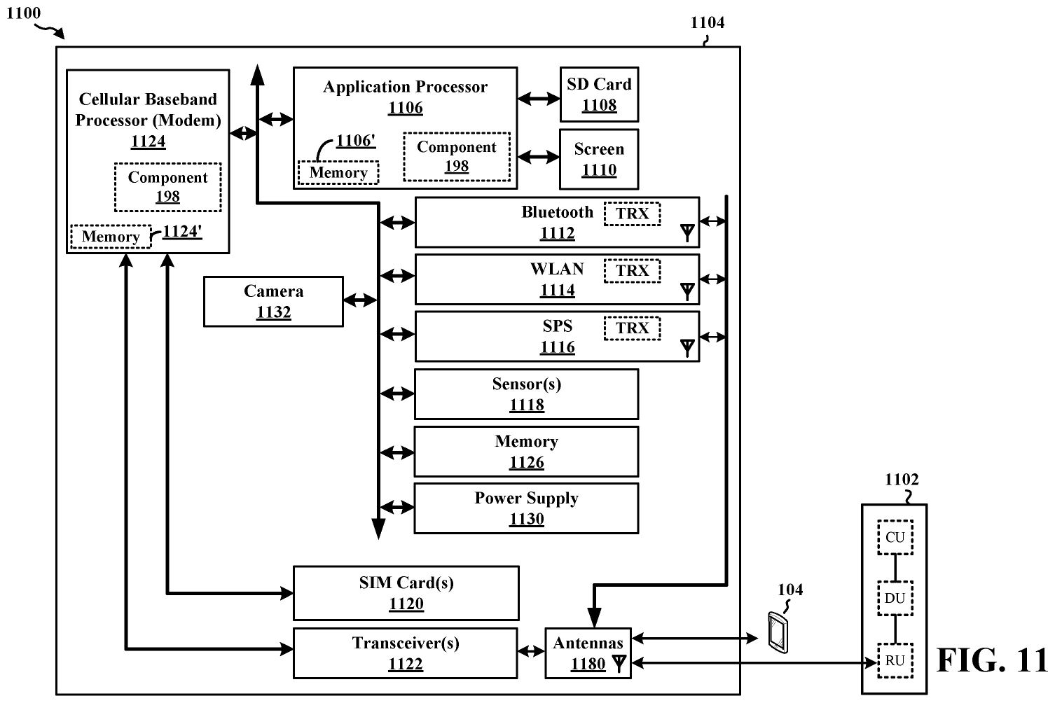

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the reference component 198 may be configured to receive, from a network entity (e.g., a base station), an indication indicating a reference BWP or CC for a common TCI pool shared by a set of BWPs or CCs. In some aspects, the reference component 198 may be further configured to communicate with the network entity (e.g., the base station) based on the reference BWP or CC.

In some aspects, the reference component 198 may be configured to receive, from a network entity (e.g., the base station), a configuration of a reference BWP or CC for a common TCI pool shared by a set of BWPs or CCs. In some aspects, the Reference component 198 may be further configured to receive, from the network entity (e.g., the base station), one or more candidate sets of PC parameters associated with the set of BWPs or CCs. In some aspects, the reference component 198 may be further configured to communicate with the network entity (e.g., the base station) based on the one or more candidate sets of PCs. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving, from a network entity (e.g., a base station), an indication indicating a reference BWP or CC for a common TCI pool shared by a set of BWPs or CCs. The apparatus 1104 may further include means for communicating with the network entity (e.g., the base station) based on the reference BWP or CC. The apparatus 1104 may further include means for receiving, from a network entity (e.g., the base station), a configuration of a reference BWP or CC for a common TCI pool shared by a set of BWPs or CCs. The apparatus 1104 may further include means for receiving, from the network entity (e.g., the base station), one or more candidate sets of PC parameters associated with the set of BWPs or CCs. The apparatus 1104 may further include means for communicating with the network entity (e.g., the base station) based on the one or more candidate sets of PCs. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

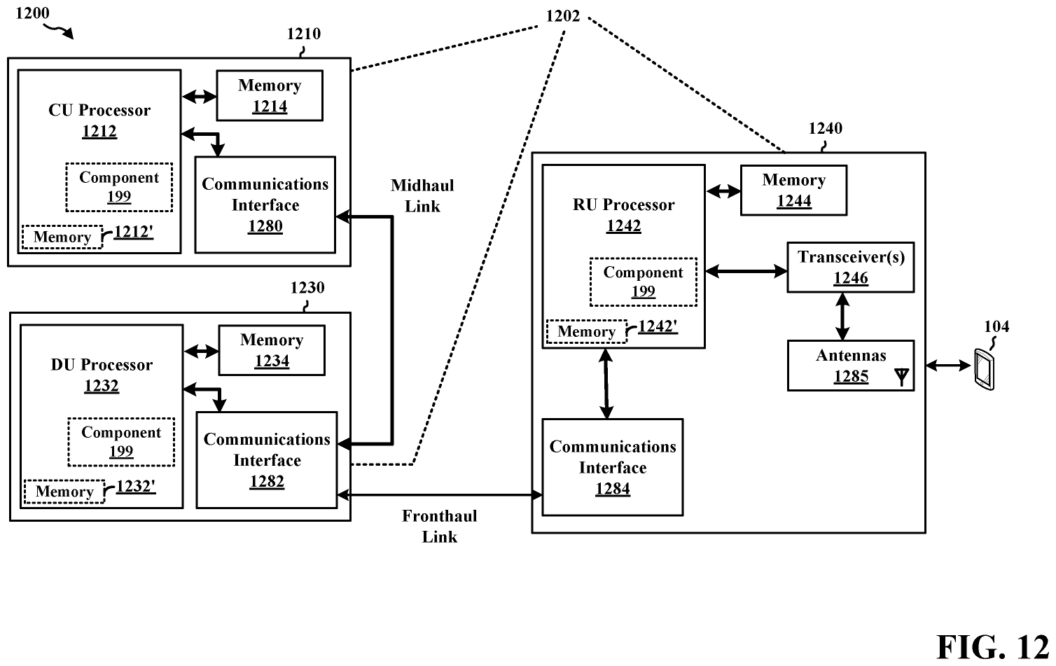

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1280. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1282. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1285, and a communications interface 1284. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the reference component 199 may be configured to transmit an indication indicating a reference BWP or CC for a common TCI pool shared by a set of BWPs or CCs. In some aspects, the reference component 199 may be further configured to communicate based on the reference BWP or CC. In some aspects, the reference component 199 may be configured to transmit, to a UE, a configuration of a reference BWP or CC for a common TCI pool shared by a set of BWPs or CCs. In some aspects, the reference component 199 may be further configured to transmit, to the UE, one or more candidate sets of PC parameters associated with the set of BWPs or CCs. In some aspects, the reference component 199 may be further configured to communicate with the UE based on the one or more candidate sets of PCs. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202, may include means for transmitting, to a UE, an indication indicating a reference BWP or CC for a common TCI pool shared by a set of BWPs or CCs. The network entity 1202 may further include means for communicating with the UE based on the reference BWP or CC. The network entity 1202 may include means for transmitting, to a UE, a configuration of a reference BWP or CC for a common TCI pool shared by a set of BWPs or CCs. The network entity 1202 may further include means for transmitting, to the UE, one or more candidate sets of PC parameters associated with the set of BWPs or CCs. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

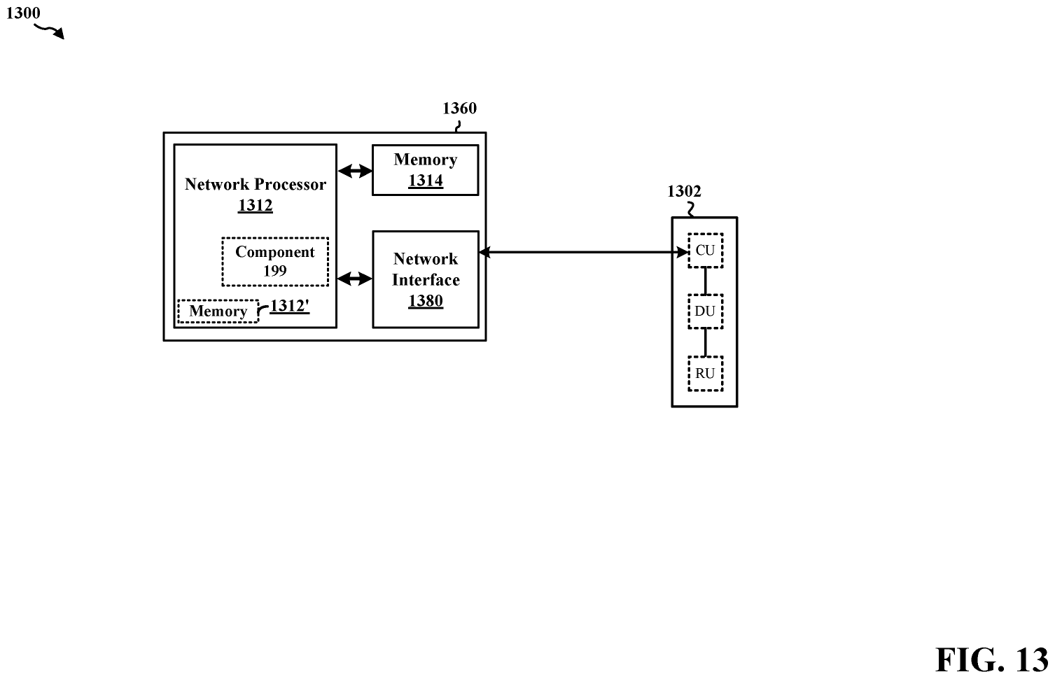

FIG. 13 is a diagram 1300 illustrating an example of a hardware implementation for a network entity 1360. In one example, the network entity 1360 may be within the core network 120. The network entity 1360 may include a network processor 1312. The network processor 1312 may include on-chip memory 1312′. In some aspects, the network entity 1360 may further include additional memory modules 1314. The network entity 1360 communicates via the network interface 1380 directly (e.g., backhaul link) or indirectly (e.g., through a RIC) with the CU 1302. The on-chip memory 1312′ and the additional memory modules 1314 may each be considered a computer-readable medium/memory. Each computer-readable medium/memory may be non-transitory. The processor 1312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the reference component 199 may be configured to transmit an indication indicating a reference BWP or CC for a common TCI pool shared by a set of BWPs or CCs. In some aspects, the reference component 199 may be further configured to communicate based on the reference BWP or CC. In some aspects, the reference component 199 may be configured to transmit, to a UE, a configuration of a reference BWP or CC for a common TCI pool shared by a set of BWPs or CCs. In some aspects, the reference component 199 may be further configured to transmit, to the UE, one or more candidate sets of PC parameters associated with the set of BWPs or CCs. In some aspects, the reference component 199 may be further configured to communicate with the UE based on the one or more candidate sets of PCs. The component 199 may be within the processor 1312. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1360 may include a variety of components configured for various functions. In one configuration, the network entity 1360, may include means for transmitting, to a UE, an indication indicating a reference BWP or CC for a common TCI pool shared by a set of BWPs or CCs. The network entity 1360 may further include means for communicating with the UE based on the reference BWP or CC. The network entity 1360 may include means for transmitting, to a UE, a configuration of a reference BWP or CC for a common TCI pool shared by a set of BWPs or CCs. The network entity 1360 may further include means for transmitting, to the UE, one or more candidate sets of PC parameters associated with the set of BWPs or CCs. The means may be the component 199 of the network entity 1360 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a UE, comprising: a memory; and at least one processor coupled to the memory and, based at least in part on information stored in the memory, the at least one processor is configured to: receive, from a network entity (e.g., a base station), an indication indicating a reference BWP or CC for a common TCI pool shared by a set of BWPs or CCs; and communicate with the network entity (e.g., the base station) based on the reference BWP or CC. The apparatus may further include a transceiver or an antenna coupled with the at least one processor.

Aspect 2 is the apparatus of aspect 1, wherein a common TCI state ID associated with the common TCI pool comprises QCL information associated with a PDCCH, a PDSCH, a PUCCH, or a PUSCH.

Aspect 3 is the apparatus of any of aspects 1-2, wherein each BWP or each CC that is associated with the reference BWP or CC in the set of BWPs or CCs is configured with an indicator to refer to the reference BWP or CC.

Aspect 4 is the apparatus of any of aspects 1-3, wherein the indication comprises a list of BWPs or CCs associated with the reference BWP or CC.

Aspect 5 is the apparatus of any of aspects 1-4, wherein each BWP or CC in the set of BWPs or CCs is associated with the reference BWP or CC.

Aspect 7 is the apparatus of any of aspects 1-5, wherein the indication is a BWP ID or a cell ID, and wherein the reference BWP or CC is a BWP or CC with a lowest BWP ID or a lowest cell ID in a frequency band.

Aspect 7 is the apparatus of any of aspects 1-6, wherein the indication is associated with a BWP (such as the BWP).

Aspect 9 is the apparatus of any of aspects 1-7, wherein the indication is associated with the set of BWPs.

Aspect 9 is the apparatus of any of aspects 1-8, further comprising a transceiver.

Aspect 10 is an apparatus for wireless communication at a network entity (e.g., a base station), comprising: a memory; and at least one processor coupled to the memory and, based at least in part on information stored in the memory, the at least one processor is configured to: transmit, to a UE, an indication indicating a reference BWP or CC for a common TCI pool shared by a set of BWPs or CCs; and communicate with the UE based on the reference BWP or CC. The apparatus may further include a transceiver or an antenna coupled with the at least one processor.

Aspect 11 is the apparatus of aspect 10, wherein a common TCI state ID associated with the TCI pool comprises QCL information associated with a PDCCH, a PDSCH, a PUCCH, or a PUSCH.

Aspect 12 is the apparatus of any of aspects 10-11, wherein each BWP or each CC that is associated with the reference BWP or CC in the set of BWPs or CCs is configured with an indicator to refer to the reference BWP or CC.

Aspect 13 is the apparatus of any of aspects 10-12, wherein the indication comprises a list of BWPs or CCs associated with the reference BWP or CC.

Aspect 14 is the apparatus of any of aspects 10-13, wherein each BWP or CC in the set of BWPs or CCs is associated with the reference BWP or CC.

Aspect 15 is the apparatus of any of aspects 10-14, wherein the indication is a BWP ID or a cell ID, and wherein the reference BWP or CC is a BWP or CC with a lowest BWP ID or a lowest cell ID in a frequency band.

Aspect 16 is the apparatus of any of aspects 10-15, wherein the indication is associated with a BWP (such as the BWP).

Aspect 17 is the apparatus of any of aspects 10-16, wherein the indication is associated with the set of BWPs.

Aspect 18 is the apparatus of any of aspects 10-17, further comprising a transceiver.

Aspect 19 is a method of wireless communication for implementing any of aspects 1 to 9.

Aspect 20 is an apparatus for wireless communication including means for implementing any of aspects 1 to 9.

Aspect 21 is a computer-readable medium storing computer executable code, where the code when executed by a processor causes the processor to implement any of aspects 1 to 9.

Aspect 22 is a method of wireless communication for implementing any of aspects 10 to 18.

Aspect 23 is an apparatus for wireless communication including means for implementing any of aspects 10 to 18.

Aspect 24 is a computer-readable medium storing computer executable code, where the code when executed by a processor causes the processor to implement any of aspects 10 to 18.

Aspect 25 is an apparatus for wireless communication at a UE, comprising: a memory; and at least one processor coupled to the memory and, based at least in part on information stored in the memory, the at least one processor is configured to: receive, from a network entity (e.g., the base station), a configuration of a reference BWP or CC for a common TCI pool shared by a set of BWPs or CCs; receive, from the network entity (e.g., the base station), one or more candidate sets of PC parameters associated with the set of BWPs or CCs; and communicate with the network entity (e.g., the base station) based on the one or more candidate sets of PCs. The apparatus may further include a transceiver or an antenna coupled with the at least one processor.

Aspect 26 is the apparatus of aspect 25, wherein a common TCI state ID associated with the TCI pool comprises QCL information associated with a PDCCH, a PDSCH, a PUCCH, or a PUSCH.

Aspect 27 is the apparatus of any of aspects 25-26, wherein the one or more candidate sets of PC parameters are common and shared by one or more BWPs or CCs in the set of BWPs or CCs.

Aspect 28 is the apparatus of any of aspects 25-27, wherein the one or more candidate sets of PC parameters comprises one common set of PC parameters per each TCI in the common TCI pool.

Aspect 29 is the apparatus of any of aspects 25-28, wherein the one common set of PC parameters per each TCI in the common TCI pool is included in the configuration.

Aspect 30 is the apparatus of any of aspects 25-29, wherein the one common set of PC parameters per each TCI in the common TCI pool is associated with MAC-CE.

Aspect 31 is the apparatus of any of aspects 25-30, wherein the one or more candidate sets of PC parameters comprises one common set of PC parameters per each SRS resource set.

Aspect 32 is the apparatus of any of aspects 25-31, wherein the one or more candidate sets of PC parameters are associated with the reference BWP or CC.

Aspect 33 is the apparatus of any of aspects 25-32, wherein the one or more candidate sets of PC parameters are configured per BWP or CC.

Aspect 34 is the apparatus of any of aspects 25-33, wherein each candidate set of the one or more candidate sets of PC parameters is associated with an SRS resource set.

Aspect 35 is the apparatus of any of aspects 25-34, wherein each candidate set of the one or more candidate sets of PC parameters is associated with a TCI in the common TCI pool.

Aspect 36 is the apparatus of any of aspects 25-35, further comprising a transceiver.

Aspect 37 is an apparatus for wireless communication at a network entity (e.g., the base station), comprising: a memory; and at least one processor coupled to the memory and, based at least in part on information stored in the memory, the at least one processor is configured to: transmit a configuration of a reference BWP or CC for a common TCI pool shared by a set of BWPs or CCs; transmit one or more candidate sets of PC parameters associated with the set of BWPs or CCs; and communicate based on the one or more candidate sets of PCs. The apparatus may further include a transceiver or an antenna coupled with the at least one processor.

Aspect 38 is the apparatus of aspect 37, wherein a common TCI state ID associated with the TCI pool comprises QCL information associated with a PDCCH, a PDSCH, a PUCCH, or a PUSCH.

Aspect 39 is the apparatus of any of aspects 37-38, wherein the one or more candidate sets of PC parameters are common and shared by one or more BWPs or CCs in the set of BWPs or CCs.

Aspect 40 is the apparatus of any of aspects 37-39, wherein the one or more candidate sets of PC parameters comprises one common set of PC parameters per each TCI in the common TCI pool.

Aspect 41 is the apparatus of any of aspects 37-40, wherein the one common set of PC parameters per each TCI in the common TCI pool is included in the configuration.

Aspect 42 is the apparatus of any of aspects 37-41, wherein the one common set of PC parameters per each TCI in the common TCI pool is associated with MAC-CE.

Aspect 43 is the apparatus of any of aspects 37-42, wherein the one or more candidate sets of PC parameters comprises one common set of PC parameters per each SRS resource set.

Aspect 44 is the apparatus of any of aspects 37-43, wherein the one or more candidate sets of PC parameters are associated with the reference BWP or CC.

Aspect 45 is the apparatus of any of aspects 37-44, wherein the one or more candidate sets of PC parameters are configured per BWP or CC.

Aspect 46 is the apparatus of any of aspects 37-45, wherein each candidate set of the one or more candidate sets of PC parameters is associated with an SRS resource set.

Aspect 47 is the apparatus of any of aspects 37-46, wherein each candidate set of the one or more candidate sets of PC parameters is associated with a TCI in the common TCI pool.

Aspect 48 is the apparatus of any of aspects 37-47, further comprising a transceiver.

Aspect 49 is a method of wireless communication for implementing any of aspects 25 to 36.

Aspect 50 is an apparatus for wireless communication including means for implementing any of aspects 25 to 36.

Aspect 51 is a computer-readable medium storing computer executable code, where the code when executed by a processor causes the processor to implement any of aspects 25 to 36.

Aspect 52 is a method of wireless communication for implementing any of aspects 37 to 48.

Aspect 53 is an apparatus for wireless communication including means for implementing any of aspects 37 to 48.

Aspect 54 is a computer-readable medium storing computer executable code, where the code when executed by a processor causes the processor to implement any of aspects 37 to 48.

What is claimed is:

1. An apparatus for wireless communication at a user equipment (UE), comprising:
a memory; and
at least one processor coupled to the memory and, based at least in part on information stored in the memory, the at least one processor is configured to:
receive, from a network entity, an indication indicating a reference bandwidth part (BWP) or component carrier (CC) for a common transmission configuration indicator (TCI) pool shared by a set of BWPs or CCs; and
communicate with the network entity based on the reference BWP or CC.

2. The apparatus of claim 1, wherein a common TCI state ID associated with the common TCI pool comprises quasi-colocation (QCL) information associated with a physical downlink control channel (PDCCH), a physical downlink shared channel (PDSCH), a physical uplink control channel (PUCCH), or a physical uplink shared channel (PUSCH).

3. The apparatus of claim 1, wherein each BWP or each CC that is associated with the reference BWP or CC in the set of BWPs or CCs is configured with an indicator to refer to the reference BWP or CC.

4. The apparatus of claim 1, wherein the indication comprises a list of BWPs or CCs associated with the reference BWP or CC.

5. The apparatus of claim 1, wherein each BWP or CC in the set of BWPs or CCs is associated with the reference BWP or CC.

6. The apparatus of claim 1, wherein the indication is a BWP identifier (ID) or a cell ID, and wherein the reference BWP or CC is a BWP or CC with a lowest BWP ID or a lowest cell ID in a frequency band.

7. The apparatus of claim 1, wherein the indication is associated with the BWP.

8. The apparatus of claim 1, wherein the indication is associated with the set of BWPs.

9. The apparatus of claim 1, further comprising a transceiver or an antenna coupled to the at least one processor.

10. An apparatus for wireless communication at a network entity, comprising:
a memory; and
at least one processor coupled to the memory and, based at least in part on information stored in the memory, the at least one processor is configured to:
transmit an indication indicating a reference bandwidth part (BWP) or component carrier (CC) for a common transmission configuration indicator (TCI) pool shared by a set of BWPs or CCs; and
communicate based on the reference BWP or CC.

11. The apparatus of claim 10, wherein a common TCI state ID associated with the TCI pool comprises quasi-colocation (QCL) information associated with a physical downlink control channel (PDCCH), a physical downlink shared channel (PDSCH), a physical uplink control channel (PUCCH), or a physical uplink shared channel (PUSCH).

12. The apparatus of claim 10, wherein each BWP or each CC that is associated with the reference BWP or CC in the set of BWPs or CCs is configured with an indicator to refer to the reference BWP or CC.

13. The apparatus of claim 10, wherein the indication comprises a list of BWPs or CCs associated with the reference BWP or CC.

14. The apparatus of claim 10, wherein each BWP or CC in the set of BWPs or CCs is associated with the reference BWP or CC.

15. The apparatus of claim 10, wherein the indication is a BWP identifier (ID) or a cell ID, and wherein the reference BWP or CC is a BWP or CC with a lowest BWP ID or a lowest cell ID in a frequency band.

16. The apparatus of claim 10, wherein the indication is associated with the BWP.

17. The apparatus of claim 10, wherein the indication is associated with the set of BWPs.

18. The apparatus of claim 10, further comprising a transceiver or an antenna coupled to the at least one processor.

19. An apparatus for wireless communication at a user equipment (UE), comprising:
a memory; and
at least one processor coupled to the memory and, based at least in part on information stored in the memory, the at least one processor is configured to:
receive, from a network entity, a configuration of a reference bandwidth part (BWP) or component carrier (CC) for a common transmission configuration indicator (TCI) pool shared by a set of BWPs or CCs;
receive, from the network entity, one or more candidate sets of power control (PC) parameters associated with the set of BWPs or CCs; and
communicate with the network entity based on the one or more candidate sets of PCs.

20. The apparatus of claim 19, wherein a common TCI state ID associated with the TCI pool comprises quasi-colocation (QCL) information associated with a physical downlink control channel (PDCCH), a physical downlink shared channel (PDSCH), a physical uplink control channel (PUCCH), or a physical uplink shared channel (PUSCH).

21. The apparatus of claim 19, wherein the one or more candidate sets of PC parameters are common and shared by one or more BWPs or CCs in the set of BWPs or CCs.

22. The apparatus of claim 21, wherein the one or more candidate sets of PC parameters comprises one common set of PC parameters per each TCI in the common TCI pool.

23. The apparatus of claim 22, wherein the one common set of PC parameters per each TCI in the common TCI pool is included in the configuration.

24. The apparatus of claim 22, wherein the one common set of PC parameters per each TCI in the common TCI pool is associated with medium access control (MAC) control element (CE) (MAC-CE).

25. The apparatus of claim 21, wherein the one or more candidate sets of PC parameters comprises one common set of PC parameters per each sounding reference signal (SRS) resource set.

26. The apparatus of claim 19, wherein the one or more candidate sets of PC parameters are associated with the reference BWP or CC.

27. The apparatus of claim 19, wherein the one or more candidate sets of PC parameters are configured per BWP or CC.

28. The apparatus of claim 19, wherein each candidate set of the one or more candidate sets of PC parameters is associated with a sounding reference signal (SRS) resource set.

29. The apparatus of claim 19, wherein each candidate set of the one or more candidate sets of PC parameters is associated with a TCI in the common TCI pool.

30. An apparatus for wireless communication at a network entity, comprising:
a memory; and
at least one processor coupled to the memory and, based at least in part on information stored in the memory, the at least one processor is configured to:
transmit a configuration of a reference bandwidth part (BWP) or component carrier (CC) for a common transmission configuration indicator (TCI) pool shared by a set of BWPs or CCs;
transmit one or more candidate sets of power control (PC) parameters associated with the set of BWPs or CCs; and
communicate based on the one or more candidate sets of PCs.
